(19) United States
(12) Patent Application Publication
(10) Pub. No.: US 2022/0085443 A1
(43) Pub. Date: Mar. 17, 2022

(54) PLASTIC CELL SWELLING RESTRAINT FEATURE

(71) Applicant: CPS Technology Holdings LLC, New York, NY (US)

(72) Inventors: Eric Kar Wai Lee, Antioch, IL (US); Nicholas E. Elison, Mequon, WI (US); Jordan David Petrie, Wauwatosa, WI (US)

(21) Appl. No.: 17/422,833

(22) PCT Filed: Jan. 17, 2020
(86) PCT No.: PCT/US2020/014058

§ 371 Date: Jul. 14, 2021

Related U.S. Application Data
(60) Provisional application No. 62/793,718, filed on Jan. 17, 2019.

(51) Int. Cl. H01M 50/112; H01M 50/116; H01M 50/103

(52) U.S. Cl. CPC H01M 50/112; H01M 50/103; H01M 50/116

(57) ABSTRACT

Disclosed is an advanced battery module comprising a feature for the restraint of cell swelling. In particular, disclosed is an advanced battery module for a vehicle, comprising a housing having a first wall, second wall, third wall, and fourth wall wherein the first wall is perpendicular to the second wall and fourth wall, and the third wall is parallel to the first wall, wherein the first wall comprises a first wall member, a second wall member parallel to the first wall member, and a plurality of first wall cross-members extending between the first wall member and second wall member; wherein the plurality of first wall cross-members are angled relative to the first wall, at least the first wall and the third wall comprising a plastic; and a plurality of cells.

### CROSS-REFERENCE TO RELATED APPLICATIONS

This application claims priority to application No. 62/793,718 filed Jan. 17, 2019, the entirety of which is incorporated herein by reference.

### FIELD

The present disclosure relates to the field of batteries. The present disclosure more specifically relates to the field of battery housings.

### BACKGROUND

Lithium ion cells are generally housed in an injection molded plastic housing. The cells create internal pressure and expand due to typical electrical loading. The pressure creates great force that is difficult to constrain with only a single-wall plastic housing. Accordingly, many existing devices use a metal constraint to control the expansion or swelling and pressure on the single-wall plastic housing. Unfortunately, using metal adds weight, manufacturing complexity, and cost to the battery.

### SUMMARY

Accordingly, a battery housing having a plastic cell swelling restraint feature is provided which solves one or more of the problems faced by existing devices. The disclosed battery housing may, in various embodiments, allow for restraint on cell swelling while minimizing increase in weight to the battery.

Disclosed is a housing for an advanced battery module, the housing comprising: a first wall comprising a first wall member; a second wall member parallel to the first wall member; and a plurality of cross-members extending between the first wall member and second wall member; wherein the plurality of cross-members are angled relative to the first wall member. Further disclosed is a housing comprising a second wall and a fourth wall, both the second wall and fourth wall being perpendicular to the first wall, and a third wall; wherein the third wall comprises: a third wall member; a fourth wall member parallel to the third wall member; and a plurality of cross-members extending between the third wall member and the fourth wall member; wherein the plurality of cross-members are angled relative to the third wall member. Further disclosed is a housing wherein the plurality of cross-members are neither perpendicular nor parallel to the first wall member. Further disclosed is a housing wherein the first wall comprises a plastic. Disclosed herein is an advanced battery having the housing described herein.

Disclosed is a n advanced battery module for a vehicle, comprising: a housing having a first wall, the first wall comprising: a first wall member; a second wall member parallel to the first wall member; and a plurality of cross-members extending between the first wall member and second wall member; wherein the plurality of cross-members are angled relative to the first wall member; and a plurality of cells. Further disclosed is an advanced battery module wherein the housing further comprises: a second wall, a third wall, and a fourth wall; wherein the third wall comprises: a third wall member; a fourth wall member parallel to the third wall member; and a plurality of third wall cross-members extending between the third wall member and the fourth wall member; wherein the plurality of third wall cross-members are neither parallel nor perpendicular to the third wall member. Further disclosed is an advanced battery module wherein the first wall and third wall are parallel to each other, the second wall is perpendicular to the first wall, and the fourth wall is parallel to the second wall. Further disclosed is an advanced battery module wherein the first wall comprises a plastic. Further disclosed is an advanced battery module wherein the plurality of cells are prismatic. Further disclosed is an advanced battery module wherein a long edge of each cell in the plurality of cells is oriented parallel to the first wall. Further disclosed is an advanced battery module wherein the plurality of cross-members comprises a first cross-member and a second cross-member oriented in a different angle to the first wall member than the second cross-member. Further disclosed is an advanced battery module wherein the first cross-member is essentially perpendicular to the second cross-member. Further disclosed is an advanced battery module wherein the plurality of cross-members are neither parallel nor perpendicular to the first wall member. Further disclosed is an advanced battery module wherein a long edge of the prismatic cell is neither parallel nor perpendicular to the first cross-member or the second cross-member.

Disclosed herein is an advanced battery module for a vehicle, comprising: a housing having a first wall, second wall, third wall, and fourth wall; wherein the first wall is perpendicular to the second wall and fourth wall, and the third wall is parallel to the first wall; wherein the first wall comprises: a first wall member; a second wall member parallel to the first wall member; and a plurality of first wall cross-members extending between the first wall member and second wall member; wherein the plurality of first wall cross-members are angled relative to the first wall member; and wherein the third wall comprises: a third wall member; a fourth wall member; and a plurality of third wall cross-members extending between the third wall member and fourth wall member; wherein the plurality of third wall cross-members are angled relative to the third wall member; at least the first wall and the third wall comprising a plastic; and a plurality of cells. Further disclosed is an advanced battery module wherein the plurality of first wall cross-members comprise a first cross-member and a second cross-member, the first cross-member intersecting the first wall at a different angle than the second cross-member. Further disclosed is an advanced battery module wherein the plurality of cells are prismatic. Further disclosed is an advanced battery module, wherein a long edge of at least one of the plurality of cells is parallel to the first wall. Further disclosed is an advanced battery module, wherein the plurality of first wall cross-members are neither parallel nor perpendicular to the first wall member and wherein the plurality of third wall cross-members are neither parallel nor perpendicular to the third wall member.

Further advantages may be understood from the detailed disclosure herein.

### BRIEF DESCRIPTION OF DRAWINGS

Various examples of embodiments of the systems, devices, and methods disclosed will be described in detail, with reference to the following figures, wherein:

FIG. 1 illustrates a vehicle having a battery which may utilize the cell swelling restraint feature disclosed herein;

FIG. 2 shows a battery housing which may comprise the cell swelling restraint feature according to various embodiments as disclosed herein;

FIG. 3 shows a battery housing having a cover removed and having the cell swelling restraint feature according to various embodiments as disclosed herein; and

FIG. 4 shows a top view of a battery housing with the cover removed, showing battery cells within the battery housing and the cell swelling restraint feature according to various examples of embodiments as disclosed herein.

It should be understood that the drawings are not necessarily to scale. In certain instances, details that are not necessary to the understanding of the invention or render other details difficult to perceive may have been omitted. It should be understood, of course, that the invention is not necessarily limited to the particular embodiments illustrated herein.

### DETAILED DESCRIPTION

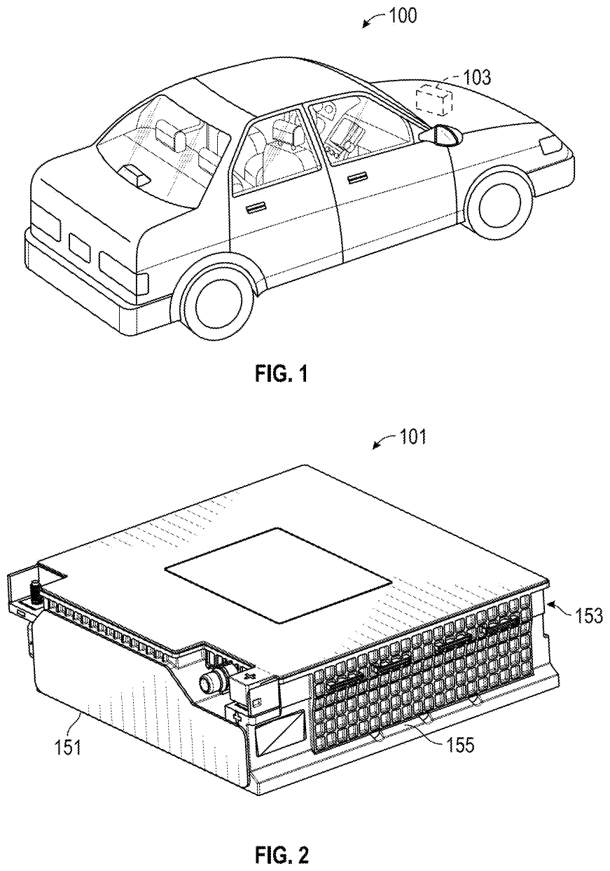

Referring to FIG. 1, a vehicle 100 is shown. Within the vehicle 100, a battery 103 is provided to support operational functionality of the vehicle. For example, battery 103 may be an advanced battery such as a lithium ion battery (while lithium ion is provided, other advanced battery chemistries may be considered as within the scope of this disclosure). This advanced battery 103 may be comprised of a plurality of cells as shown and described herein. These cells 267 may undergo swelling during operation of vehicle 100 as result of the use of the battery 103. Therefore housing 101, 201, may incorporate certain cell swelling restraint features as shown and described further herein.

FIG. 2 shows a housing 101 for a battery. As may be seen, a lid, bottom (not shown), first wall 151, second wall 155, third wall 153, and fourth wall (not shown) may be understood to define an exterior of the battery. The housing 101 may be understood to be sized to fit within a vehicle 103. The battery housing 101 may be understood to comprise a plastic.

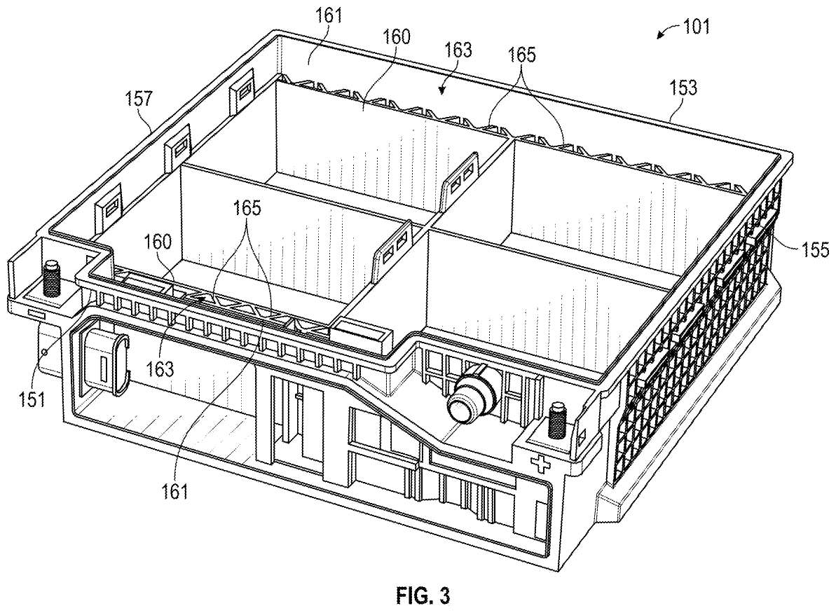

Referring to FIG. 3, a battery housing 103 is shown with the cover removed, again having a first wall 151, second wall 155, third wall 153, and fourth wall 157. First wall 151 and third wall 153 may be understood to each further comprise a cell swelling restraint feature. In detail, the cell swelling restraint feature may comprise a double wall 163 which may be comprised of plastic. The double wall 163 may comprise a first wall member 160 and second wall member 161. Angled cross-members 165 may be seen spanning between the first wall member 160 and second wall member 161. In various embodiments, second wall 155 and fourth wall 157 may not comprise the cell swelling restraint feature. While two walls having the cell swelling restraint feature are shown, permutations thereon (one, three, or four cell swelling restraint features, etc.) should be contemplated as within the scope of this disclosure. Cross-members 165 may be seen intersecting with the first wall member 160 at an angle.

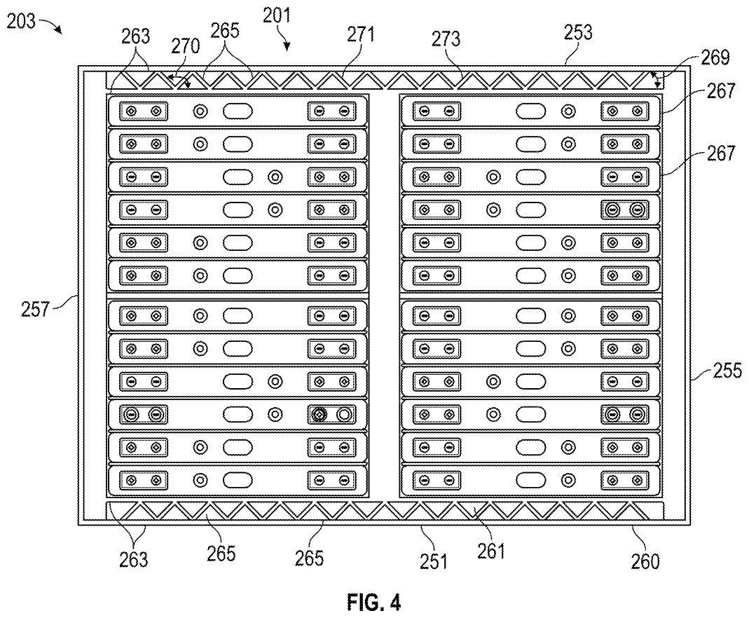

Turning to FIG. 4, another embodiment of a battery housing 201 is shown with the cover removed, now showing battery cells 267 within the battery housing 201 and the restraint feature. Battery cells 267 may be seen as prismatic, having two relatively longer sides extending in parallel to first wall 251 and third wall 253. Battery housing 201 may be understood to be a plastic battery housing. Again, the housing may be understood as provided for holding a plurality of battery cells 267 or a battery pack assembly. The battery housing has a bottom or base (not shown), two end walls (251, 253), two side walls (255, 257), and may also include, in some examples of embodiments, one or more dividing walls which divide the battery cells. The battery housing 201 may also include a cover (not shown). As can be seen in FIG. 4, the end walls (first wall 251 and second wall 253) comprise a double-wall structure while the side walls (second wall 255 and fourth wall 257) and dividing walls may be seen as comprising a single solid wall. However, it is contemplated that more walls or fewer walls may have the double-wall structure. Likewise, it is contemplated that more walls or fewer walls may be a single solid wall.

In the illustrated example, each end wall (first wall 251 and/or third wall 253) comprises a plastic double-wall structure 263 or assembly having angled cross members 265 between two adjacent, but spaced apart longitudinal wall members (first wall member 260, second wall member 261). This structure on the end walls 251 and 253 (including but not limited to first wall member 260, second wall member 261, and angled cross members 265) may be understood to provide constraint against swelling for battery cells contained within the battery housing (cell-swelling restraint feature). The thickness of each wall (260, 261) of the plastic double-wall structure, the number of angled cross members 265, the angle of the cross member(s) (first angle 269, second angle 270), and thicknesses may be varied depending upon the desired structural and performance characteristics, which may be dictated by any number of different and suitable parameters, such as, but not limited to, desired wall strength, desired thickness, manufacturing preferences, and so forth. The thickness of each wall of the housing (251, 253, 255, 257) may also vary. In various embodiments, the first angle 269 may differ as measured from the wall member 260 from the second angle 270. In various embodiments, first angle 269 may be from the intersection of the second cross member 271 with a wall member 263 and second angle 270 may be measured based on the intersection between a first cross member 271 with the same wall member 263. In some non-limiting embodiments, first cross member 271 and second cross member 273 may be substantially perpendicular to each other. While a particular configuration of cross members is shown and described, variations thereon may be understood as within the scope of this disclosure.

In one or more examples of embodiments, the housing may be formed by injection molding. However, alternative processes may also be suitable for the purposes provided.

Advantageously, the plastic restraint feature, namely the plastic double-wall structure with angled cross members described herein, may have advantages to manufacturability. For example, instead of manufacturing and assembling a separate metal piece, additional plastic structure can be integrated into the housing. Moreover, there are fewer parts in the battery pack. Eliminating a metal structure inside the housing may provide advantages to battery size and allow for reduction in overall weight of the battery.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that references to relative positions (e.g., “top” and “bottom”) in this description are merely used to identify various elements as are oriented in the Figures. It should be recognized that the orientation of particular components may vary greatly depending on the application in which they are used.

For the purpose of this disclosure, the term “coupled” means the joining of two members directly or indirectly to one another. Such joining may be stationary in nature or moveable in nature. Such joining may be achieved with the two members or the two members and any additional intermediate members being integrally formed as a single unitary body with one another or with the two members or the two members and any additional intermediate members being attached to one another. Such joining may be permanent in nature or may be removable or releasable in nature.

It is also important to note that the construction and arrangement of the system, methods, and devices as shown in the various examples of embodiments is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements show as multiple parts may be integrally formed, the operation of the interfaces may be reversed or otherwise varied, the length or width of the structures and/or members or connector or other elements of the system may be varied, the nature or number of adjustment positions provided between the elements may be varied (e.g. by variations in the number of engagement slots or size of the engagement slots or type of engagement). The order or sequence of any process or method steps may be varied or re-sequenced according to alternative embodiments. Other substitutions, modifications, changes and omissions may be made in the design, operating conditions and arrangement of the various examples of embodiments without departing from the spirit or scope of the present inventions.

While this invention has been described in conjunction with the examples of embodiments outlined above, various alternatives, modifications, variations, improvements and/or substantial equivalents, whether known or that are or may be presently foreseen, may become apparent to those having at least ordinary skill in the art. Accordingly, the examples of embodiments of the invention, as set forth above, are intended to be illustrative, not limiting. Various changes may be made without departing from the spirit or scope of the invention. Therefore, the invention is intended to embrace all known or earlier developed alternatives, modifications, variations, improvements and/or substantial equivalents.

The technical effects and technical problems in the specification are exemplary and are not limiting. It should be noted that the embodiments described in the specification may have other technical effects and can solve other technical problems.

What is claimed is:

1. A housing for an advanced battery module, the housing comprising:
a first wall comprising:
a first wall member;
a second wall member parallel to the first wall member; and
a plurality of cross-members extending between the first wall member and second wall member;
wherein the plurality of cross-members are angled relative to the first wall member.

2. The housing of claim 1, wherein the housing further comprises:
a second wall and a fourth wall, both the second wall and fourth wall being perpendicular to the first wall, and a third wall;
wherein the third wall comprises:
a third wall member;
a fourth wall member parallel to the third wall member; and
a plurality of cross-members extending between the third wall member and the fourth wall member;
wherein the plurality of cross-members are angled relative to the third wall member.

3. The housing of claim 1, wherein the plurality of cross-members are neither perpendicular nor parallel to the first wall member.

4. The housing of claim 1, wherein the first wall comprises a plastic.

5. An advanced battery having the housing of claim 1.

6. An advanced battery module for a vehicle, comprising:
a housing having a first wall, the first wall comprising:
a first wall member;
a second wall member parallel to the first wall member; and
a plurality of cross-members extending between the first wall member and second wall member;
wherein the plurality of cross-members are angled relative to the first wall member; and
a plurality of cells.

7. The advanced battery module of claim 6, wherein the housing further comprises:
a second wall, a third wall, and a fourth wall;
wherein the third wall comprises:
a third wall member;
a fourth wall member parallel to the third wall member; and
a plurality of third wall cross-members extending between the third wall member and the fourth wall member;
wherein the plurality of third wall cross-members are neither parallel nor perpendicular to the third wall member.

8. The advanced battery module of claim 7, wherein the first wall and third wall are parallel to each other, the second wall is perpendicular to the first wall, and the fourth wall is parallel to the second wall.

9. The advanced battery module of claim 6, wherein the first wall comprises a plastic.

10. The advanced battery module of claim 6, wherein the plurality of cells are prismatic.

11. The advanced battery module of claim 10, wherein a long edge of each cell in the plurality of cells is oriented parallel to the first wall.

12. The advanced battery module of claim 6, wherein the plurality of cross-members comprises a first cross-member and a second cross-member oriented in a different angle to the first wall member than the second cross-member.

13. The advanced battery module of claim 12, wherein the first cross-member is essentially perpendicular to the second cross-member.

14. The advanced battery module of claim 10, wherein the plurality of cross-members are neither parallel nor perpendicular to the first wall member.

15. The advanced battery module of claim 10, wherein a long edge of the prismatic cell is neither parallel nor perpendicular to the first cross-member or the second cross-member.

16. An advanced battery module for a vehicle, comprising:
a housing having a first wall, second wall, third wall, and fourth wall;
wherein the first wall is perpendicular to the second wall and fourth wall, and the third wall is parallel to the first wall;
wherein the first wall comprises:
a first wall member;
a second wall member parallel to the first wall member; and
a plurality of first wall cross-members extending between the first wall member and second wall member;
wherein the plurality of first wall cross-members are angled relative to the first wall member; and
wherein the third wall comprises:
a third wall member;
a fourth wall member; and
a plurality of third wall cross-members extending between the third wall member and fourth wall member;
wherein the plurality of third wall cross-members are angled relative to the third wall member;
at least the first wall and the third wall comprising a plastic; and
a plurality of cells.

17. The advanced battery module of claim 15, wherein the plurality of first wall cross-members comprise a first cross-member and a second cross-member, the first cross-member intersecting the first wall at a different angle than the second cross-member.

18. The advanced battery module of claim 15, wherein the plurality of cells are prismatic.

19. The advanced battery module of claim 17, wherein a long edge of at least one of the plurality of cells is parallel to the first wall.

20. The advanced battery module of claim 16, wherein the plurality of first wall cross-members are neither parallel nor perpendicular to the first wall member and wherein the plurality of third wall cross-members are neither parallel nor perpendicular to the third wall member.
